(19) United States
(12) Patent Application Publication
(10) Pub. No.: US 2009/0300616 A1
(43) Pub. Date: Dec. 3, 2009

(54) AUTOMATED TASK EXECUTION FOR AN ANALYTE MONITORING SYSTEM

(75) Inventors: Jeffrey Mario Sicurello, Union City, CA (US); Mark K. Sloan, Redwood City, CA (US)

Correspondence Address: JACKSON & CO., LLP, 6114 LA SALLE AVENUE, #507, OAKLAND, CA, 94611-2802, US

(73) Assignee: Abbott Diabetes Care, Inc., Alameda, CA (US)

(21) Appl. No.: 12/130,999

(22) Filed: May 30, 2008

(51) Int. Cl. G06F 9/46

(52) U.S. Cl. 718/100

(57) ABSTRACT

In one aspect, method and apparatus including providing one or more scheduled tasks associated with an analyte monitoring device and executing the scheduled one or more tasks in accordance with a predetermined execution sequence are provided.

### BACKGROUND

Analyte, e.g., glucose monitoring systems including continuous and discrete monitoring systems generally include a small, lightweight battery powered and microprocessor controlled system which is configured to detect signals proportional to the corresponding measured glucose levels using an electrometer. RF signals may be used to transmit the collected data. One aspect of certain analyte monitoring systems include a transcutaneous or subcutaneous analyte sensor configuration which is, for example, at least partially positioned through the skin layer of a subject whose analyte level is to be monitored. The sensor may use a two or three-electrode (work, reference and counter electrodes) configuration driven by a controlled potential (potentiostat) analog circuit connected through a contact system.

An analyte sensor may be configured so that a portion thereof is placed under the skin of the patient so as to contact analyte of the patient, and another portion or segment of the analyte sensor may be in communication with the transmitter unit. The transmitter unit may be configured to transmit the analyte levels detected by the sensor over a wireless communication link such as an RF (radio frequency) communication link to a receiver/monitor unit. The receiver/monitor unit may perform data analysis, among other functions, on the received analyte levels to generate information pertaining to the monitored analyte levels.

### SUMMARY

Devices and methods for analyte monitoring, e.g., glucose monitoring, are provided. Embodiments include transmitting information from a first location to a second, e.g., using a telemetry system such as RF telemetry. In particular, embodiments include method and apparatus for providing one or more scheduled tasks associated with an analyte monitoring device and executing the scheduled one or more tasks in accordance with a predetermined execution sequence.

These and other objects, features and advantages of the present disclosure will become more fully apparent from the following detailed description of the embodiments, the appended claims and the accompanying drawings.

### BRIEF DESCRIPTION OF THE DRAWINGS

FIG. 1 illustrates a block diagram of a data monitoring and management system for practicing one or more embodiments of the present disclosure;

FIG. 2 is a block diagram of the transmitter unit of the data monitoring and management system shown in FIG. 1 in accordance with one embodiment of the present disclosure;

FIG. 3 is a block diagram of the receiver/monitor unit of the data monitoring and management system shown in FIG. 1 in accordance with one embodiment of the present disclosure;

FIG. 4 is a timeline illustrating the tasks performed in one Scheduler time frame in accordance with one embodiment of the present disclosure;

FIG. 5 is a flow chart illustrating the tasks performed by the Scheduler finite state machine in accordance with one embodiment of the present disclosure;

FIG. 6 is a flowchart illustrating data processing of the received data packet including the rolling data in accordance with one embodiment of the present disclosure;

FIG. 7 is a flowchart illustrating data communication using close proximity commands in the data monitoring and management system of FIG. 1 in accordance with one embodiment of the present disclosure;

FIG. 8 is a flowchart illustrating the pairing or synchronization routine in the data monitoring and management system of FIG. 1 in accordance with one embodiment of the present disclosure; and

FIG. 9 is a flowchart illustrating the pairing or synchronization routine in the data monitoring and management system of FIG. 1 in accordance with another embodiment of the present disclosure.

### DETAILED DESCRIPTION

As summarized above and as described in further detail below, in accordance with the various embodiments of the present disclosure, there are provided a method and apparatus for providing one or more scheduled tasks associated with an analyte monitoring device and executing the scheduled one or more tasks in accordance with a predetermined execution sequence. Embodiments further include detecting a start command, retrieving a predetermined task schedule time frame for execution of one or more routines associated with analyte level detection, and executing the one or more routines in accordance with the predetermined task schedule time frame.

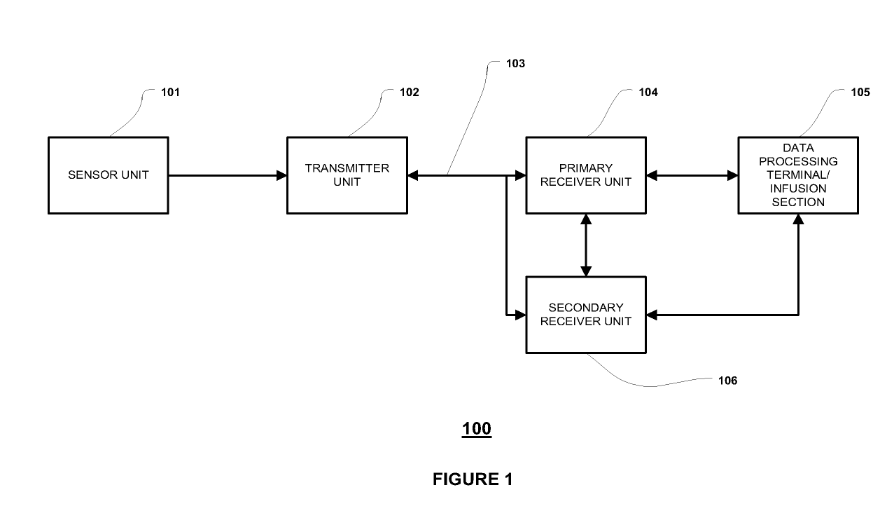

FIG. 1 illustrates a data monitoring and management system such as, for example, an analyte (e.g., glucose) monitoring system 100 in accordance with one embodiment of the present disclosure. The subject disclosure is further described primarily with respect to a glucose monitoring system for convenience and such description is in no way intended to limit the scope of the disclosure. It is to be understood that the analyte monitoring system may be configured to monitor a variety of analytes, e.g., lactate, and the like.

Analytes that may be monitored include, for example, acetyl choline, amylase, bilirubin, cholesterol, chorionic gonadotropin, creatine kinase (e.g., CK-MB), creatine, DNA, fructosamine, glucose, glutamine, growth hormones, hormones, ketones, lactate, peroxide, prostate-specific antigen, prothrombin, RNA, thyroid stimulating hormone, and troponin. The concentration of drugs, such as, for example, antibiotics (e.g., gentamicin, vancomycin, and the like), digitoxin, digoxin, drugs of abuse, theophylline, and warfarin, may also be monitored. More than one analyte may be monitored by a single system, e.g. a single analyte sensor.

In one embodiment, the analyte monitoring system 100 includes a sensor unit 101, a transmitter unit 102 coupleable to the sensor unit 101, and a primary receiver unit 104 which is configured to communicate with the transmitter unit 102 via a bi-directional communication link 103. The primary receiver unit 104 may be further configured to transmit data to a data processing terminal 105 for evaluating the data received by the primary receiver unit 104. Moreover, the data processing terminal 105 in one embodiment may be configured to receive data directly from the transmitter unit 102 via a communication link which may optionally be configured for bi-directional communication. Accordingly, transmitter unit 102 and/or receiver unit 104 may include a transceiver.

Also shown in FIG. 1 is an optional secondary receiver unit 106 which is operatively coupled to the communication link and configured to receive data transmitted from the transmitter unit 102. Moreover, as shown in the Figure, the secondary receiver unit 106 is configured to communicate with the primary receiver unit 104 as well as the data processing terminal 105. Indeed, the secondary receiver unit 106 may be configured for bi-directional wireless communication with each or one of the primary receiver unit 104 and the data processing terminal 105. As discussed in further detail below, in one embodiment of the present disclosure, the secondary receiver unit 106 may be configured to include a limited number of functions and features as compared with the primary receiver unit 104. As such, the secondary receiver unit 106 may be configured substantially in a smaller compact housing or embodied in a device such as a wrist watch, pager, mobile phone, or PDA, for example. Alternatively, the secondary receiver unit 106 may be configured with the same or substantially similar functionality as the primary receiver unit 104. The receiver unit may be configured to be used in conjunction with a docking cradle unit, for example for one or more of the following or other functions: placement by bedside, for re-charging, for data management, for night time monitoring, and/or bi-directional communication device.

In one aspect, sensor unit 101 may include two or more sensors, each configured to communicate with transmitter unit 102. Furthermore, while only one, transmitter unit 102, communication link 103, and data processing terminal 105 are shown in the embodiment of the analyte monitoring system 100 illustrated in FIG. 1, it will be appreciated by one of ordinary skill in the art that the analyte monitoring system 100 may include one or more sensors, multiple transmitter units 102, communication links 103, and data processing terminals 105. Moreover, within the scope of the present disclosure, the analyte monitoring system 100 may be a continuous monitoring system, or semi-continuous, or a discrete monitoring system. In a multi-component environment, each device is configured to be uniquely identified by each of the other devices in the system so that communication conflict is readily resolved between the various components within the analyte monitoring system 100.

In one embodiment of the present disclosure, the sensor unit 101 is physically positioned in or on the body of a user whose analyte level is being monitored. The sensor unit 101 may be configured to continuously sample the analyte level of the user and convert the sampled analyte level into a corresponding data signal for transmission by the transmitter unit 102. In certain embodiments, the transmitter unit 102 may be physically coupled to the sensor unit 101 so that both devices are integrated in a single housing and positioned on the user's body. The transmitter unit 102 may perform data processing such as filtering and encoding on data signals and/or other functions, each of which corresponds to a sampled analyte level of the user, and in any event transmitter unit 102 transmits analyte information to the primary receiver unit 104 via the communication link 103.

In one embodiment, the analyte monitoring system 100 is configured as a one-way RF communication path from the transmitter unit 102 to the primary receiver unit 104. In such embodiment, the transmitter unit 102 transmits the sampled data signals received from the sensor unit 101 without acknowledgement from the primary receiver unit 104 that the transmitted sampled data signals have been received. For example, the transmitter unit 102 may be configured to transmit the encoded sampled data signals at a fixed rate (e.g., at one minute intervals) after the completion of the initial power on procedure. Likewise, the primary receiver unit 104 may be configured to detect such transmitted encoded sampled data signals at predetermined time intervals. Alternatively, the analyte monitoring system 100 may be configured with a bi-directional RF (or otherwise) communication between the transmitter unit 102 and the primary receiver unit 104.

Additionally, in one aspect, the primary receiver unit 104 may include two sections. The first section is an analog interface section that is configured to communicate with the transmitter unit 102 via the communication link 103. In one embodiment, the analog interface section may include an RF receiver and an antenna for receiving and amplifying the data signals from the transmitter unit 102, which are thereafter, demodulated with a local oscillator and filtered through a band-pass filter. The second section of the primary receiver unit 104 is a data processing section which is configured to process the data signals received from the transmitter unit 102 such as by performing data decoding, error detection and correction, data clock generation, and data bit recovery.

In operation, upon completing the power-on procedure, the primary receiver unit 104 is configured to detect the presence of the transmitter unit 102 within its range based on, for example, the strength of the detected data signals received from the transmitter unit 102 and/or a predetermined transmitter identification information. Upon successful synchronization with the corresponding transmitter unit 102, the primary receiver unit 104 is configured to begin receiving from the transmitter unit 102 data signals corresponding to the user's detected analyte level. More specifically, the primary receiver unit 104 in one embodiment is configured to perform synchronized time hopping with the corresponding synchronized transmitter unit 102 via the communication link 103 to obtain the user's detected analyte level.

Referring again to FIG. 1, the data processing terminal 105 may include a personal computer, a portable computer such as a laptop or a handheld device (e.g., personal digital assistants (PDAs)), and the like, each of which may be configured for data communication with the receiver via a wired or a wireless connection. Additionally, the data processing terminal 105 may further be connected to a data network (not shown) for storing, retrieving and updating data corresponding to the detected analyte level of the user.

Within the scope of the present disclosure, the data processing terminal 105 may include an infusion device such as an insulin infusion pump (external or implantable) or the like, which may be configured to administer insulin to patients, and which may be configured to communicate with the receiver unit 104 for receiving, among others, the measured analyte level. Alternatively, the receiver unit 104 may be configured to integrate or otherwise couple to an infusion device therein so that the receiver unit 104 is configured to administer insulin therapy to patients, for example, for administering and modifying basal profiles, as well as for determining appropriate boluses for administration based on, among others, the detected analyte levels received from the transmitter unit 102.

Additionally, the transmitter unit 102, the primary receiver unit 104 and the data processing terminal 105 may each be configured for bi-directional wireless communication such that each of the transmitter unit 102, the primary receiver unit 104 and the data processing terminal 105 may be configured to communicate (that is, transmit data to and receive data from) with each other via the wireless communication link 103. More specifically, the data processing terminal 105 may in one embodiment be configured to receive data directly from the transmitter unit 102 via the communication link 106, where the communication link 106, as described above, may be configured for bi-directional communication.

In this embodiment, the data processing terminal 105 which may include an insulin pump, may be configured to receive the analyte signals from the transmitter unit 102, and thus, incorporate the functions of the receiver 103 including data processing for managing the patient's insulin therapy and analyte monitoring. In one embodiment, the communication link 103 may include one or more of an RF communication protocol, an infrared communication protocol, a Bluetooth enabled communication protocol, an 802.11x wireless communication protocol, or an equivalent wireless communication protocol which would allow secure, wireless communication of several units (for example, per HIPPA requirements) while avoiding potential data collision and interference.

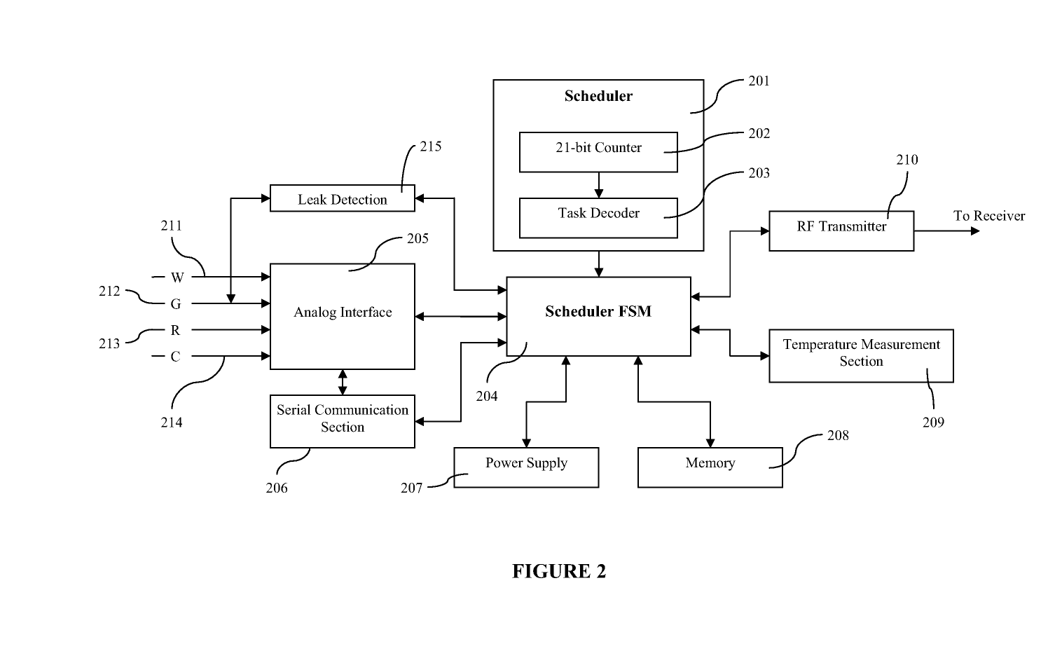

FIG. 2 is a block diagram of the transmitter of the data monitoring and detection system shown in FIG. 1 in accordance with one embodiment of the present disclosure. Referring to FIG. 2, the transmitter unit 102 in one embodiment includes a decoded timer (for example, Scheduler 201), configured to control task calls and timing of one or more operations or functions in the transmitter unit 102. In one aspect, the Scheduler 201 may include a 21-bit counter 202 configured to run at 32.768 KHz and a task decoder 203 to decode the timer output. Within the scope of the present disclosure, the Scheduler may include one or more counters of greater or less bits, and further, configured to run at a different frequency.

In one aspect, the Scheduler 201 is operatively coupled to a Scheduler finite state machine (FSM) 204, which is configured to execute tasks assigned or called by the Scheduler 201 by, for example, transmitting control signals to one or more components, units or sections in the transmitter unit 102. Referring back to FIG. 2, in one embodiment, the Scheduler FSM 204 is operatively coupled to, among others, an analog interface 205, a serial communication section 206, a power supply 207, a memory 208, a temperature measurement section 209, and/or an RF transmitter 210. Alternatively, one or more microprocessors may be provided to the transmitter unit 102 and operatively coupled to the Scheduler 201, and configured to process the task signals received from the Scheduler 201 and execute one or more the corresponding tasks or functions. In still another aspect, one or more state machines, and one or more microprocessors may be configured in the transmitter unit 102 to perform, process, execute, provide redundant processing, or apportion certain of the called functions or tasks for processing and/or execution.

As discussed in further detail below, and referring back to FIG. 2, the counter 202 may be configured to count a 60 second frame starting from 0 second to 60 seconds, and when the counter 202 reaches the end of the frame, the counter 202 may be reset and the associated functions, tasks, or processes are repeated. Each task to be performed during each frame may be hardcoded into the decoder 203, and when the count from the counter 202 associated with a particular task is reached, a task signal associated with the particular task may become active. When the task signal becomes active, the task signal may be processed or called by the Scheduler FSM 204, and the associated task function may be executed. In one aspect, the Scheduler 201 and the Scheduler FSM 204 are started by an initialization state machine after the initialization state machine receives a start command, such as a close proximity start command discussed in further detail below.

Referring back to FIG. 2, in one embodiment, a unidirectional input path is established from the sensor unit 101 (FIG. 1) and/or manufacturing and testing equipment to the analog interface 205 of the transmitter unit 102. As can be seen from FIG. 2, there are provided four contacts, three of which are electrodes—work electrode (W) 211, guard contact (G) 212, reference electrode (R) 213, and counter electrode (C) 214, each operatively coupled to the analog interface 205 of the transmitter unit 102 for connection to the sensor unit 101 (FIG. 1). In one embodiment, each of the work electrode (W) 211, guard contact (G) 212, reference electrode (R) 213, and counter electrode (C) 214 may be made using a conductive material that is either printed or etched or ablated, for example, such as carbon which may be printed, or a metal such as a metal foil (e.g., gold) or the like, which may be etched or ablated or otherwise processed to provide one or more electrodes. Fewer or greater electrodes and/or contact may be provided in certain embodiments.

Referring still to FIG. 2, in one embodiment, a unidirectional output is established from the output of the RF transmitter 210 of the transmitter unit 102 for transmission to the primary receiver unit 104. As such, in one embodiment, via the data path described above, the transmitter unit 102 is configured to transmit to the primary receiver unit 104 (FIG. 1), via the communication link 103 (FIG. 1), processed and encoded data signals received from the sensor unit 101 (FIG. 1). Additionally, the unidirectional communication data path between the analog interface 205 and the RF transmitter 210 discussed above allows for the configuration of the transmitter unit 102 for operation upon completion of the manufacturing process as well as for direct communication for diagnostic and testing purposes.

Referring yet again to FIG. 2, memory 208 of the transmitter unit 102 may be configured to store data such as the identification information for the transmitter unit 102, as well as the data signals received from the sensor unit 101. The stored information may be retrieved and processed for transmission to the primary receiver unit 104 under the control of the Scheduler FSM 204 and based on the scheduled timing for the one or more functions of the transmitter unit 102 of the scheduler 201.

Referring back to FIG. 2, the power supply section 207 of the transmitter unit 102 in one embodiment may include a rechargeable battery unit that may be recharged by a separate power supply recharging unit (for example, provided in the receiver unit 104) so that the transmitter unit 102 may be powered for a longer period of usage time. Moreover, in one embodiment, the transmitter unit 102 may be configured without a battery in the power supply section 207, in which case the transmitter unit 102 may be configured to receive power from an external power supply source (for example, a battery). In still another aspect, the power supply section 207 may include a disposable battery.

In certain embodiments, the transmitter unit 102 is also configured such that the power supply section 207 is capable of providing power to the transmitter unit 102 for a minimum of about three months of continuous operation, e.g., after having been stored for about eighteen months such as stored in a low-power (non-operating) mode, for example, drawing no more than approximately 1 μA of current. Indeed, in one embodiment, during the manufacturing process of the transmitter unit 102, the transmitter unit 102 may be placed in the lower power, non-operating state (i.e., post-manufacture sleep mode). In this manner, the shelf life of the transmitter unit 102 may be significantly improved.

Referring yet again to FIG. 2, the temperature detection section 209 of the transmitter unit 102 is configured to monitor the temperature of the skin near the sensor insertion site. The temperature reading is used to adjust the analyte readings obtained from the analog interface 205. In certain embodiments, the RF transmitter 210 of the transmitter unit 102 may be configured for operation in the frequency band of approximately 315 MHz to approximately 322 MHz, for example, in the United States. In certain embodiments, the RF transmitter 210 of the transmitter unit 102 may be configured for operation in the frequency band of approximately 400 MHz to approximately 470 MHz. Further, in one embodiment, the RF transmitter 210 is configured to modulate the carrier frequency by performing Frequency Shift Keying and Manchester encoding. In one embodiment, the data transmission rate is about 19,200 symbols per second, with a minimum transmission range for communication with the primary receiver unit 104.

Referring yet again to FIG. 2, also shown is a leak detection circuit 215 coupled to the guard electrode (G) 212 and the Scheduler FSM 204 in the transmitter unit 102 of the data monitoring and management system 100. The leak detection circuit 215 in accordance with one embodiment of the present disclosure may be configured to detect leakage current in the sensor unit 101 to determine whether the measured sensor data are corrupt or whether the measured data from the sensor 101 is accurate.

Analyte systems, methods, and sensors that may be employed are described in, for example, U.S. Pat. Nos. 6,103,033, 6,134,461, 6,175,752, 6,121,611, 6,560,471, 6,746,582, and elsewhere, the disclosures of each of which are incorporated by reference for all purposes.

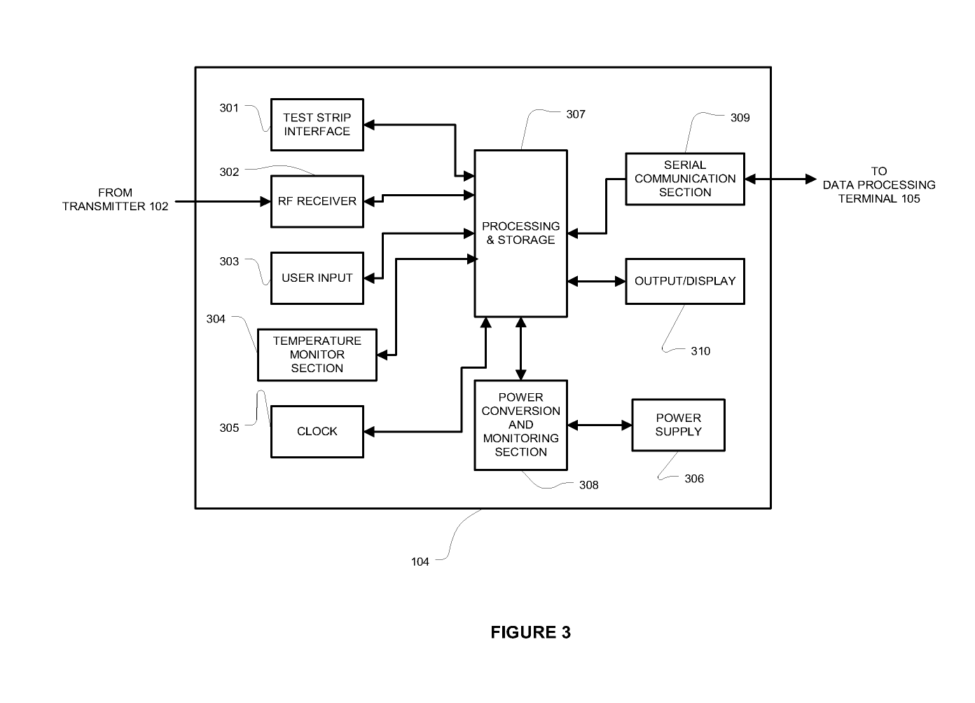

FIG. 3 is a block diagram of the receiver/monitor unit of the data monitoring and management system shown in FIG. 1 in accordance with one embodiment of the present disclosure. Referring to FIG. 3, the primary receiver unit 104 includes an analyte test strip, e.g., blood glucose test strip, interface 301, an RF receiver 302, an input 303, a temperature detection section 304, and a clock 305, each of which is operatively coupled to a receiver processor 307. As can be further seen from the Figure, the primary receiver unit 104 also includes a power supply 306 operatively coupled to a power conversion and monitoring section 308. Further, the power conversion and monitoring section 308 is also coupled to the receiver processor 307. Moreover, also shown are a receiver serial communication section 309, and an output 310, each operatively coupled to the receiver processor 307.

In one embodiment, the test strip interface 301 includes a glucose level testing portion to receive a manual insertion of a glucose test strip, and thereby determine and display the glucose level of the test strip on the output 310 of the primary receiver unit 104. This manual testing of glucose may be used to calibrate the sensor unit 101 or otherwise. The RF receiver 302 is configured to communicate, via the communication link 103 (FIG. 1) with the RF transmitter 210 (FIG. 2) of the transmitter unit 102, to receive encoded data signals from the transmitter unit 102 for, among others, signal mixing, demodulation, and other data processing. The input 303 of the primary receiver unit 104 is configured to allow the user to enter information into the primary receiver unit 104 as needed. In one aspect, the input 303 may include one or more keys of a keypad, a touch-sensitive screen, or a voice-activated input command unit. The temperature detection section 304 is configured to provide temperature information of the primary receiver unit 104 to the receiver processor 307, while the clock 305 provides, among others, real time information to the receiver processor 307.

Each of the various components of the primary receiver unit 104 shown in FIG. 3 is powered by the power supply 306 which, in one embodiment, includes a battery. Furthermore, the power conversion and monitoring section 308 is configured to monitor the power usage by the various components in the primary receiver unit 104 for effective power management and to alert the user, for example, in the event of power usage which renders the primary receiver unit 104 in sub-optimal operating conditions. An example of such sub-optimal operating condition may include, for example, operating the vibration output mode (as discussed below) for a period of time thus substantially draining the power supply 306 while the processor 307 (thus, the primary receiver unit 104) is turned on. Moreover, the power conversion and monitoring section 308 may additionally be configured to include a reverse polarity protection circuit such as a field effect transistor (FET) configured as a battery activated switch.

The serial communication section 309 in the primary receiver unit 104 is configured to provide a bi-directional communication path from the testing and/or manufacturing equipment for, among others, initialization, testing, and configuration of the primary receiver unit 104. Serial communication section 104 can also be used to upload data to a computer, such as time-stamped blood glucose data. The communication link with an external device (not shown) can be made, for example, by cable, infrared (IR) or RF link. The output 310 of the primary receiver unit 104 is configured to provide, among others, a graphical user interface (GUI) such as a liquid crystal display (LCD) for displaying information. Additionally, the output 310 may also include an integrated speaker for outputting audible signals as well as to provide vibration output as commonly found in handheld electronic devices, such as mobile telephones presently available. In a further embodiment, the primary receiver unit 104 also includes an electro-luminescent lamp configured to provide backlighting to the output 310 for output visual display in dark ambient surroundings.

Referring back to FIG. 3, the primary receiver unit 104 in one embodiment may also include a storage section such as a programmable, non-volatile memory device as part of the processor 307, or provided separately in the primary receiver unit 104, operatively coupled to the processor 307. The processor 307 may be configured to synchronize with a transmitter, e.g., using Manchester decoding or the like, as well as error detection and correction upon the encoded data signals received from the transmitter unit 102 via the communication link 103.

Additional description of the RF communication between the transmitter 102 and the primary receiver 104 (or with the secondary receiver 106) that may be employed in embodiments of the subject disclosure is disclosed in pending application Ser. No. 11/060,365 filed Feb. 16, 2005 entitled “Method and System for Providing Data Communication in Continuous Glucose Monitoring and Management System”, assigned to the Assignee of the present application, and the disclosure of which is incorporated herein by reference for all purposes.

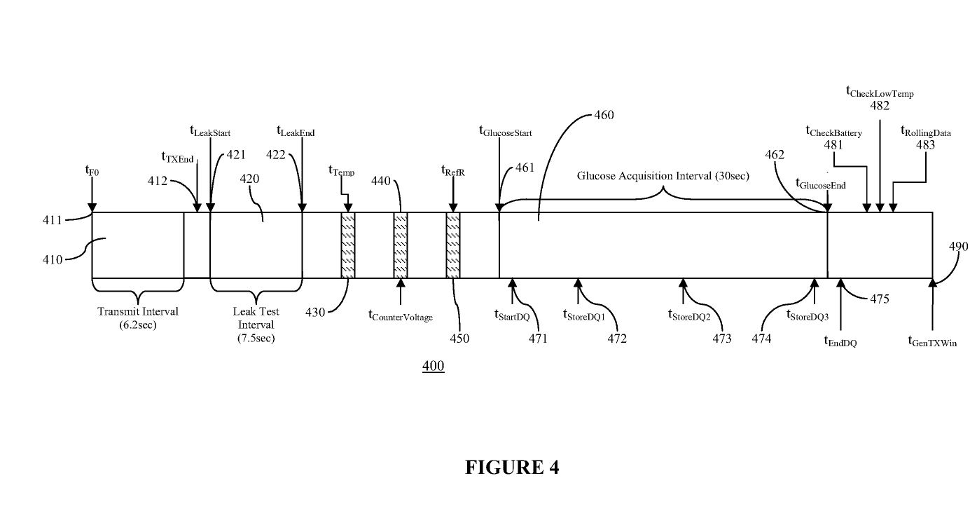

FIG. 4 is a timeline illustrating the tasks performed in one Scheduler time frame in accordance with one embodiment of the present disclosure. The Scheduler 201 (FIG. 2) includes a 21-bit counter 202 configured to run at 32.768 KHz and a task decoder 203 to decode the timer output. The counter 202 in one aspect counts from t=0 seconds to t=60 seconds, over a time frame duration of 60 seconds. When the counter 202 reaches the end of the 60 second frame, the counter 202 is reset and the process is repeated. Each task to be performed during each frame may be hardcoded into the decoder 203 (FIG. 2), and when the count from the counter 202 associated with a particular task is reached, an associated task signal is active. The active task signal is then processed by the Scheduler FSM 204, and the associated task is executed. While a 21-bit counter operating at approximately 33 KHz is described, within the scope of the present disclosure, other counters having more or less than 21 bits running at different frequencies may be used in conjunction with the scheduler FSM 204.

Referring back to FIG. 4, in one embodiment, the 60 second Scheduler time frame 400 is initialized at time t=0 seconds (t_{F0}) 411. In one embodiment, the initialization is performed by an initialization state machine that is configured to initialize the Scheduler 201 when a start command is detected. In one aspect, the detected start command may be associated with the initial power of procedure of the transmitter unit 102 (FIG. 1), or with the detection of a close proximity start command. In one aspect, the initialization of the Scheduler 201 is not configured to start with each reset of the time frame 400 at t_{F0} 411.

The beginning seconds of the time frame 400 in one aspect may be associated with one or more tasks associated with the transmission of data from the transmitter unit 102. While the transmission window 490 may be generated at the end of the time frame cycle, data transmission may be configured to occur during the first approximately 6.2 seconds of the transmission interval 410 within the time frame 400. Within the scope of the present disclosure, the transmit interval may be greater than or less than the approximately 6 seconds 410.

Referring to FIG. 4 again, in one aspect, at time t_{TXEnd} 412 within the time frame 400, a time out task may be implemented to time out the transmit window. The time out task may be configured for transmission error that may occur during the transmit interval in which case, the Scheduler 201 may be configured to proceed to the next scheduled task. After the transmit interval 410, the Scheduler 201 may be configured to call the next scheduled function associated with a leak test 420. The leak test in one aspect is configured to detect leakage current in the sensor unit 101 (FIG. 1) to determine whether the measured sensor data may be corrupt or whether the measured data from the sensor 101 has inaccuracies. The leak test interval in one aspect may be approximately 7.5 seconds in duration following the time out task within the 60 second scheduler time frame. Within the scope of the present disclosure, the leak test interval may be greater than or less than the approximately 7.5 seconds 420.

Referring yet again to FIG. 4, during the leak test interval 420, a first leak value and a second leak value shortly before the end of the leak test interval 422 may be stored. Following a wait period after the leak test routine, a scheduled temperature test 430 task may be called by the scheduler 201 and executed. In one aspect, the temperature test task 430 may include two thermistor test tasks, each having duration of approximately 125 ms during which a respective detected or monitored the thermistor value is stored. After the temperature test task 430, a counter voltage test task 440 of approximately 125 ms scheduled is called and executed, followed by a 125 ms reference resistor test task 450. Within the scope of the present disclosure, the thermistor test tasks of the temperature test task 430, the counter voltage test task 440, and the reference resistor test task 450 may be greater than or less than the approximately 125 ms.

Still referring to FIG. 4, in one embodiment, one or more of the scheduled tasks called and executed described above including the leak test task, temperature test task, the counter voltage test task and the reference resistor test task may be configured to determine whether the analyte monitoring system is operating properly and without error, and to adjust the analyte measurements to improve accuracy, as may be desired.

At approximately 27.0 seconds into the frame 400, the scheduled glucose acquisition task 461 may be initiated. The glucose acquisition interval 460 may be approximately 30 seconds in length as shown in the scheduler time frame 400. Referring back again to FIG. 4, during the scheduled glucose acquisition interval 460, initiated at the glucose acquisition 461, one or more data quality test tasks may be scheduled to be called and executed 471. The one or more data quality tests may include storing one or more data quality values at various distinct points in time within the time frame 400. For example in one embodiment, three data quality values are stored at approximately 37.0 seconds (472), approximately 47.0 seconds (473), and approximately 57 seconds (474) within the time frame 400.

In one aspect, the scheduled data quality tests 475 may be configured to terminate after the end of the glucose acquisition time period 462. Thereafter, a battery test task 481 a low temperature test task 482 may be scheduled, followed by a scheduled rolling data update 483. Thereafter, in one embodiment, a transmit window may be generated 490. While specific scheduled time and duration for one or more tasks within the time frame are described above, within the scope of the present disclosure, the order in which each of the scheduled task is called and executed, and the timing and duration of each of the scheduled task may vary depending upon, for example, system design, priority of the associated function or routine, or other variables and/or parameters.

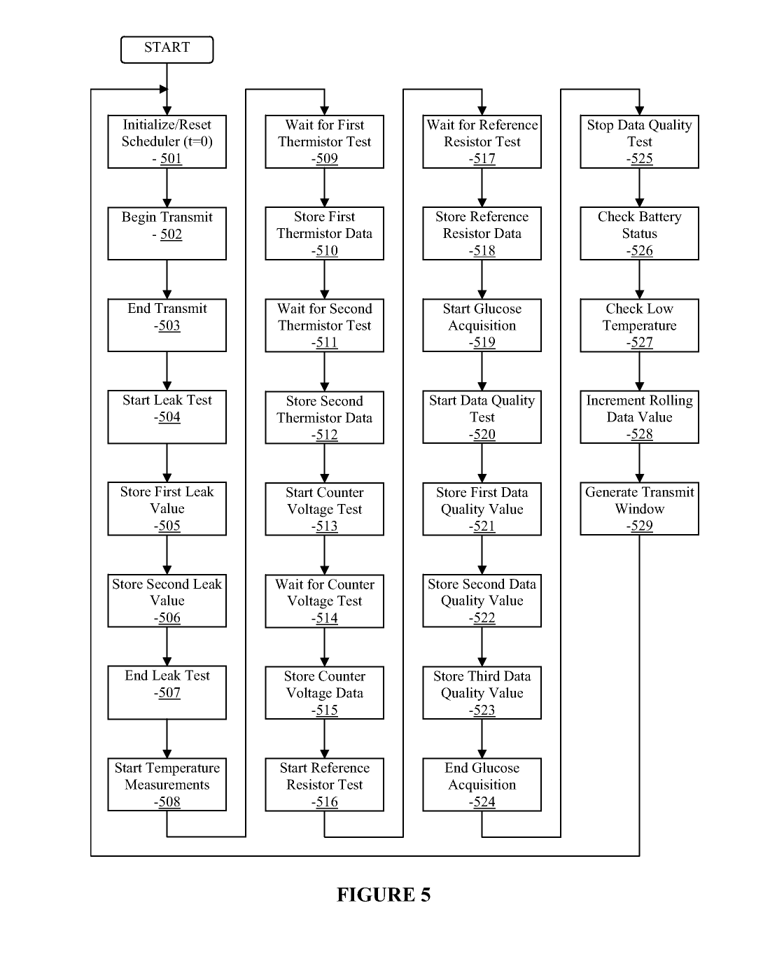

FIG. 5 illustrates the scheduled tasks performed by the Scheduler FSM 204 in accordance with one embodiment of the present disclosure. As discussed above, while each of the various scheduled tasks are described and illustrated sequentially, the one or more scheduled tasks may be ordered or scheduled to differ or include one or more variations from that illustrated in FIG. 5. For example, within the scope of the present disclosure, the number of scheduled leak test tasks may be greater or less than two as shown in FIG. 2. Further, the sequence of the scheduled tasks for the thermistor test tasks, leak test tasks, as well as other illustrated scheduled tasks may be reordered or re-scheduled.

Referring to FIG. 5, as shown, in one aspect, the Scheduler 201 is initialized (501) by an initialization state machine after the initialization state machine receives a start command, such as a close proximity start command or transmitter unit 102 power on routine. Following initialization, a transmit window opens and transmission of data begins (502). Data such as analyte related data detected by the sensor unit 101 (FIG. 1), is transmitted from the transmitter unit 102 to the primary 104 and/or secondary 106 receiver units. After transmission (or upon detection of a transmission error), an end transmission window (503) task command is called and executed such that the Scheduler FSM 204 is configured to continue to the next scheduled task.

After the transmission window terminates, as shown in FIG. 5, the next scheduled task signal received by the Scheduler FSM 204 may include one or more signals to start the leak detection test task (504). The leak test detects leakage current in the sensor unit 101 (FIG. 1) to determine whether the received sensor data are corrupt. The Scheduler FSM 204 may be configured to store a first leak value (505) and a second leak value (506) at two distinct points in time, as discussed above, and to determine whether the values fall within an acceptable leak value range. Thereafter, the Scheduler FSM 204 ends the leak test (507) and proceeds to the next scheduled task including temperature measurements (508).

The temperature detection section 209 (FIG. 2) of the transmitter unit 102 may be configured to monitor the temperature of the skin near the sensor insertion site. The temperature reading may be used to adjust the analyte level monitored by the sensor 101. In one aspect, a predetermined wait time may be associated with each temperature reading. After waiting a predetermined number of counts corresponding to a specified length of time for a first thermistor temperature reading (509), the first thermistor data reading is stored (510). Thereafter, another thermistor temperature reading task is executed (511) and the second thermistor data reading is stored (512).

Following the temperature measurement tasks, the scheduled counter voltage test is initiated (513). The counter voltage test task in one aspect includes a wait time for test completion (514). When the wait time to complete the counter voltage test task expires, the counter voltage test data is stored (515). Following the counter voltage test task, a reference resistor test task is implemented (516). After a predetermined time period for the completion of the reference resistor test task (517), the reference resistor data is stored (518). The leak detection tests (504), temperature tests (508), counter voltage test (513), and reference resistor tests (516) are all implemented in one aspect to insure the data gathered by the sensor 101 (FIG. 1) is read, stored, and analyzed accurately.

Referring still to FIG. 5, in one embodiment, following the leak test task (504), temperature test task (508), counter voltage test task (513), and reference resistor test task (516), the Scheduler FSM 204 may be configured to initiate glucose acquisition task (519). As further shown in FIG. 5, the Scheduler FSM 204 may be configured to start data quality test tasks (520), including storing a first data quality value (521), a second data quality value (522) and a third data quality value (523). After the glucose acquisition task is completed (524), the data quality test tasks are terminated (525). Following the glucose acquisition task (519) and data quality test tasks (520), the Scheduler FSM 204 may be configured to call and execute a battery status check task (526) to check if the battery of the transmitter unit 102 (FIG. 1) is below a predetermined threshold level, and a low temperature test task (527).

Referring again to FIG. 5, after completing the above-described scheduled tasks, the rolling data value for the glucose data is incremented (528) based on the glucose acquisition and data quality check information. A transmission data packet is generated from the rolling data (528), in preparation to transmit to a receiver, such as, for example, the primary receiver 104 or secondary receiver 106 of the data monitoring and management system described above in conjunction with FIG. 1. With the generated transmission data packet, a transmit window is generated (529) and the scheduled tasks are repeated over the next 60 second time frame.

Table 1 shown below is an example of scheduled task commands decoded and sent to the Scheduler FSM 204 or a processor for execution.

TABLE 1
Scheduler Tasks

| Task | HEX Value |
|---|---|
| XmitTimeOut | 041E00 |
| StartLeakTest | 041EA7 |
| TenSecondMode | 050000 |
| StoreLeakValue1 | 05FEE9 |
| StoreLeakValue2 | 07DF40 |
| StopLeakTest | 07DF65 |
| StartTempTest | 0B0000 |
| TempWait1_125 ms | 0B102A |
| TempWait2_125 ms | 0B2041 |
| StartCntrVoltage | 0C0000 |
| CntrVoltageWait_125 ms | 0C102A |
| StartRef_Resistor | 0C902A |
| RefWait_Resistor_125 ms | 0CA041 |
| GlucoseStart | 0D8000 |
| StartDQ | 0D8030 |
| StoreDQValue1 | 128030 |
| StoreDQValue2 | 178030 |
| StoreDQValue3 | 1C7999 |
| EndofGlucose | 1C8000 |
| StopDQ_Include | 1C800A |
| BatteryTest | 1CC000 |
| LowTempTest | 1CCCCC |
| IncRollingData | 1CE666 |
| GenerateTXWindow | 1CF333 |
| EndofFrame | 1DFFFE |

Referring to Table 1, in one embodiment, each HEX value associated with a specific task corresponds to a binary count of the 21-bit counter 202 (FIG. 2), which corresponds to a time value in the Scheduler frame. For example, the 21-bit counter 202 may count from “000000000000000000” to “111111111111111111111”, where “000000000000000000” corresponds to a HEX value of “000000” and a time value of 0 seconds, while “111111111111111111111” corresponds to a HEX value of “1FFFFF” and a time value of 60 seconds.

Referring still to Table 1, in one embodiment, the XmitTimeOut command is associated with a scheduled command to end the transmit window in case of transmission error. The StartLeakTest command is associated with the leak test begin task. The TenSecondMode command is associated with ten second initiate mode for the scheduled leak test task. The StoreLeakValue1 and StoreLeakValue2 commands are associated with storing the determined leak values, for example, in the memory 208. The StopLeakTest command is associated with the scheduled leak test stop task, while StartTempTest command is associated with the initiation of the scheduled temperature test task.

Referring still to Table 1 above, the TempWait1_{—}125 ms and TempWait2-125 ms commands are associated with thermistor reading tasks and storing the temperature test data. The StartCntrVoltage command is associated with the start of the counter voltage test task, and the CntrVoltageWait_{—}125 ms command is associated with determining the counter voltage readings and storing the counter voltage data. Further, the StartRef_Resistor command may be associated with the reference resistor test task initiation, and the RefWait_Resistor 125 ms command may be associated with reference resistor reading determination task, and storing the reference resistor data. As discussed, the GlucoseStart command may be associated with initiation task to initiate the glucose acquisition task, while the EndofGlucose command is associated with the termination of the scheduled glucose acquisition task.

Referring yet again to Table 1, the StartDQ command may be associated with the start of the scheduled data quality test task, and the StoreDQValue1, StoreDQValue2, and StoreDQValue3 commands are associated with reading and storing the data quality values into memory 208. Further, the StopDQ_Include command in one aspect is associated with the termination of the scheduled data quality test tasks. The BatteryTest command is associated in one aspect, with the execution of the battery status test task and the LowTempTest command is associated with the execution of the low temperature test task.

In one aspect, the IncRollingData command may be associated with incrementing the rolling data based on the data from the various scheduled tasks. The GenerateTXWindow command may be associated with the generation of a transmit window for transmitting the rolling data to a receiver, such as the primary receiver 104 (FIG. 1) or the secondary receiver 106, for example. Further, the EndofFrame command is associated with the completion or termination of the current scheduled task time frame and resetting the scheduler 201 to begin a new time frame.

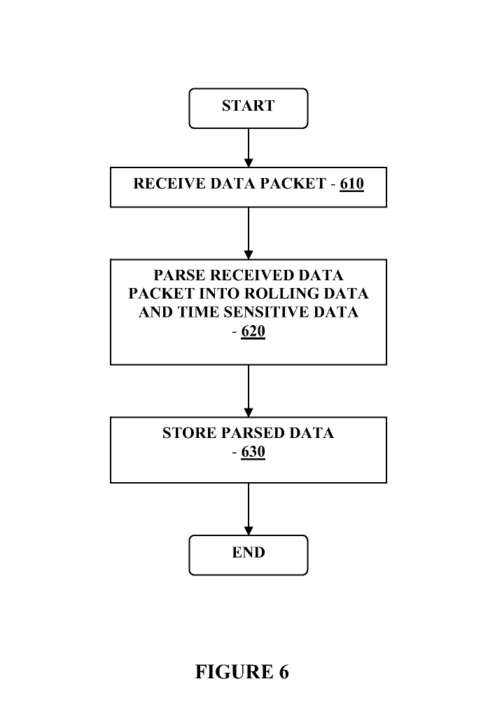

FIG. 6 is a flowchart illustrating data processing of the received data packet including the rolling data in accordance with one embodiment of the present disclosure. Referring to FIG. 6, when the data packet is received (610) (for example, by one or more of the receivers 104, 106, in one embodiment) the received data packet is parsed so that the urgent data may be separated from the not-urgent data (stored in, for example, the rolling data field in the data packet) (620). Thereafter the parsed data is suitably stored in an appropriate memory or storage device (630).

In the manner described above, in accordance with one embodiment of the present disclosure, there is provided method and apparatus for separating non-urgent type data (for example, data associated with calibration) from urgent type data (for example, monitored analyte related data) to be transmitted over the communication link to minimize the potential burden or constraint on the available transmission time. More specifically, in one embodiment, non-urgent data may be separated from data that is required by the communication system to be transmitted immediately, and transmitted over the communication link together while maintaining a minimum transmission time window. In one embodiment, the non-urgent data may be parsed or broken up in to a number of data segments, and transmitted over multiple data packets. The time sensitive immediate data (for example, the analyte sensor data, temperature data etc), may be transmitted over the communication link substantially in its entirety with each data packet or transmission.

In one embodiment, the initial sensor unit initiation command does not require the use of the close proximity key. However, other predefined or preconfigured close-proximity commands may be configured to require the use of the 8 bit key (or a key of a different number of bits). For example, in one embodiment, the receiver unit may be configured to transmit a RF on/off command to turn on/off the RF communication module or unit in the transmitter unit 102. Such RF on/off command in one embodiment includes the close proximity key as part of the transmitted command for reception by the transmitter unit.

During the period that the RF communication module or unit is turned off based on the received close proximity command, the transmitter unit does not transmit any data, including any glucose related data. In one embodiment, the glucose related data from the sensor unit which are not transmitted by the transmitter unit during the time period when the RF communication module or unit of the transmitter unit is turned off may be stored in a memory or storage unit of the transmitter unit for subsequent transmission to the receiver unit when the transmitter unit RF communication module or unit is turned back on based on the RF-on command from the receiver unit. In this manner, in one embodiment, the transmitter unit may be powered down (temporarily, for example, during air travel) without removing the transmitter unit from the on-body position.

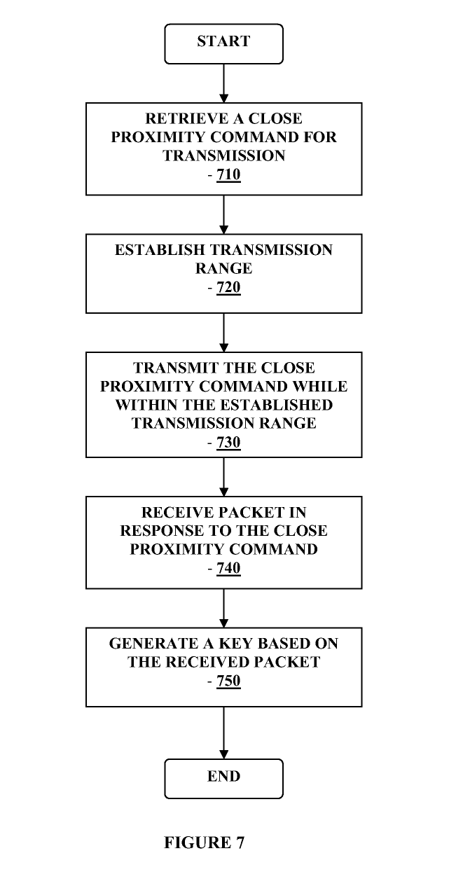

FIG. 7 is a flowchart illustrating data communication using close proximity commands in the data monitoring and management system of FIG. 1 in accordance with one embodiment of the present disclosure. Referring to FIG. 7, the primary receiver unit 104 (FIG. 1) in one aspect may be configured to retrieve or generate a close proximity command (710) for transmission to the transmitter unit 102. To establish the transmission range (720), the primary receiver unit 104 may be positioned physically close to (that is, within a predetermined distance from) the transmitter unit 102. For example, the transmission range for the close proximity communication may be established at approximately one foot distance or less between the transmitter unit 102 and the primary receiver unit 104. When the transmitter unit 102 and the primary receiver unit 104 are within the transmission range, the close proximity command, upon initiation from the receiver unit 104 may be transmitted to the transmitter unit 102 (730).

Referring back to FIG. 7, in response to the transmitted close proximity command, a response data packet or other responsive communication may be received (740). In one aspect, the response data packet or other responsive communication may include identification information of the transmitter unit 102 transmitting the response data packer or other response communication to the receiver unit 104. In one aspect, the receiver unit 104 may be configured to generate a key (for example, an 8 bit key or a key of a predetermined length) based on the transmitter identification information (750), and which may be used in subsequent close proximity communication between the transmitter unit 102 and the receiver unit 104.

In one aspect, the data communication including the generated key may allow the recipient of the data communication to recognize the sender of the data communication and confirm that the sender of the data communication is the intended data sending device, and thus, including data which is desired or anticipated by the recipient of the data communication. In this manner, in one embodiment, one or more close proximity commands may be configured to include the generated key as part of the transmitted data packet. Moreover, the generated key may be based on the transmitter ID or other suitable unique information so that the receiver unit 104 may use such information for purposes of generating the unique key for the bi-directional communication between the devices.

While the description above includes generating the key based on the transmitter unit 102 identification information, within the scope of the present disclosure, the key may be generated based on one or more other information associated with the transmitter unit 102, and/or the receiver unit combination. In a further embodiment, the key may be encrypted and stored in a memory unit or storage device in the transmitter unit 102 for transmission to the receiver unit 104.

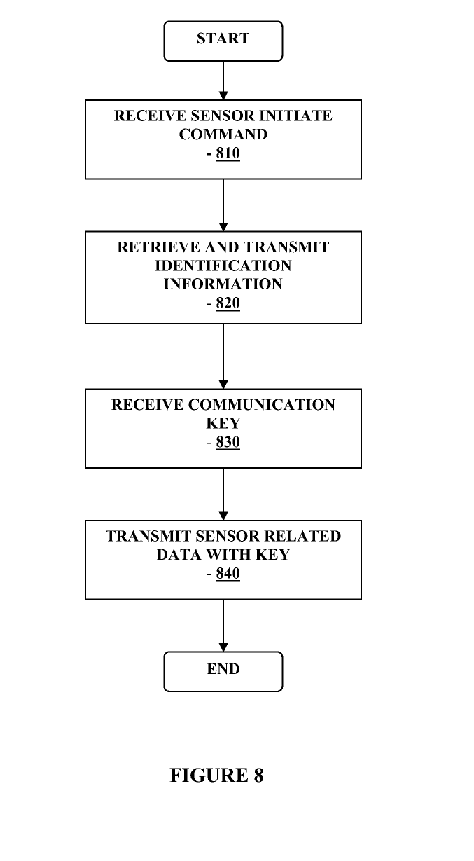

FIG. 8 is a flowchart illustrating the pairing or synchronization routine in the data monitoring and management system of FIG. 1 in accordance with one embodiment of the present disclosure. Referring to FIG. 8, in one embodiment, the transmitter unit 102 may be configured to receive a sensor initiate close proximity command (810) from the receiver unit 104 positioned within the close transmission range. Based on the received sensor initiate command, the transmitter unit identification information may be retrieved (for example, from a nonvolatile memory) and transmitted (820) to the receiver unit 104 or the sender of the sensor initiate command.

Referring back to FIG. 8, a communication key (830) optionally encrypted is received in one embodiment, and thereafter, sensor related data is transmitted with the communication key (840) on a periodic basis such as, every 60 seconds, five minutes, or any suitable predetermined time intervals.

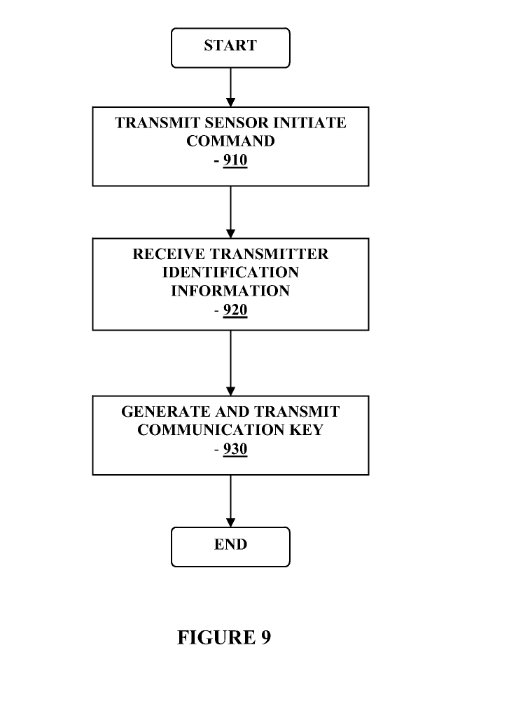

Referring now to FIG. 9, a flowchart illustrating the pairing or synchronization routine in the data monitoring and management system of FIG. 1 in accordance with another embodiment of the present disclosure is shown. That is, in one aspect, FIG. 9 illustrates the pairing or synchronization routine from the receiver unit 104. Referring back to FIG. 9, the sensor initiate command is transmitted to the transmitter unit 102 (910) when the receiver unit 104 is positioned within a close transmission range. Thereafter, in one aspect, the transmitter identification information is received (920) for example, from the transmitter unit that received the sensor initiate command. Thereafter, a communication key (optionally encrypted) may be generated and transmitted (930) to the transmitter unit.

Referring to the Figures, in one embodiment, the transmitter 102 (FIG. 1) may be configured to generate data packets for periodic transmission to one or more of the receiver units 104, 106, where each data packet includes in one embodiment two categories of data—urgent data and non-urgent data. For example, urgent data such as for example glucose data from the sensor and/or temperature data associated with the sensor may be packed in each data packet in addition to non-urgent data, where the non-urgent data is rolled or varied with each data packet transmission.

That is, the non-urgent data is transmitted at a timed interval so as to maintain the integrity of the analyte monitoring system without being transmitted over the RF communication link with each data transmission packet from the transmitter 102. In this manner, the non-urgent data, for example that are not time sensitive, may be periodically transmitted (and not with each data packet transmission) or broken up into predetermined number of segments and sent or transmitted over multiple packets, while the urgent data is transmitted substantially in its entirety with each data transmission.

Referring again to the Figures, upon receiving the data packets from the transmitter 102, the one or more receiver units 104, 106 may be configured to parse the received data packet to separate the urgent data from the non-urgent data, and also, may be configured to store the urgent data and the non-urgent data, e.g., in a hierarchical manner. In accordance with the particular configuration of the data packet or the data transmission protocol, more or less data may be transmitted as part of the urgent data, or the non-urgent rolling data. That is, within the scope of the present disclosure, the specific data packet implementation such as the number of bits per packet, and the like, may vary based on, among others, the communication protocol, data transmission time window, and so on.

In one embodiment, different types of data packets may be identified accordingly. For example, identification in certain exemplary embodiments may include—(1) single sensor, one minute of data, (2) two or multiple sensors, (3) dual sensor, alternate one minute data, and (4) response packet. For single sensor one minute data packet, in one embodiment, the transmitter 102 may be configured to generate the data packet in the manner, or similar to the manner, shown in Table 2 below.

TABLE 2
Single sensor, one minute of data

| Number of Bits | Data Field |
|---|---|
| 8 | Transmit Time |
| 14 | Sensor1 Current Data |
| 14 | Sensor1 Historic Data |
| 8 | Transmit Status |
| 12 | AUX Counter |
| 12 | AUX Thermistor 1 |
| 12 | AUX Thermistor 2 |
| 8 | Rolling-Data-1 |

As shown in Table 2 above, the transmitter data packet in one embodiment may include 8 bits of transmit time data, 14 bits of current sensor data, 14 bits of preceding sensor data, 8 bits of transmitter status data, 12 bits of auxiliary counter data, 12 bits of auxiliary thermistor 1 data, 12 bits of auxiliary thermistor 1 data and 8 bits of rolling data. In one embodiment of the present disclosure, the data packet generated by the transmitter for transmission over the RF communication link may include all or some of the data shown above in Table 2.

Referring back, the 14 bits of the current sensor data provides the real time or current sensor data associated with the detected analyte level, while the 14 bits of the sensor historic or preceding sensor data includes the sensor data associated with the detected analyte level one minute ago. In this manner, in the case where the receiver unit 104, 106 drops or fails to successfully receive the data packet from the transmitter 102 in the minute by minute transmission, the receiver unit 104, 106 may be able to capture the sensor data of a prior minute transmission from a subsequent minute transmission.

Referring again to Table 2, the Auxiliary data in one embodiment may include one or more of the patient's skin temperature data, a temperature gradient data, reference data, and counter electrode voltage. The transmitter status field may include status data that is configured to indicate corrupt data for the current transmission (for example, if shown as BAD status (as opposed to GOOD status which indicates that the data in the current transmission is not corrupt)). Furthermore, the rolling data field is configured to include the non-urgent data, and in one embodiment, may be associated with the time-hop sequence number. In addition, the Transmitter Time field in one embodiment includes a protocol value that is configured to start at zero and is incremented by one with each data packet. In one aspect, the transmitter time data may be used to synchronize the data transmission window with the receiver unit 104, 106, and also, provide an index for the Rolling data field.

In a further embodiment, the transmitter data packet may be configured to provide or transmit analyte sensor data from two or more independent analyte sensors. The sensors may relate to the same or different analyte or property. In such a case, the data packet from the transmitter 102 may be configured to include 14 bits of the current sensor data from both sensors in the embodiment in which 2 sensors are employed as shown, for example, by Table 3 below. In this case, the data packet does not include the immediately preceding sensor data in the current data packet transmission. Instead, a second analyte sensor data is transmitted with a first analyte sensor data.

TABLE 3
Dual sensor data

| Number of | |
|---|---|
| Bits | Data Field |
| 8 | Transmit Time |
| 14 | Sensor1 Current Data |
| 14 | Sensor2 Current Data |
| 8 | Transmit Status |
| 12 | AUX Counter |
| 12 | AUX Thermistor 1 |
| 12 | AUX Thermistor 2 |
| 8 | Rolling-Data-1 |

In a further embodiment, the transmitter data packet may be alternated with each transmission between two analyte sensors, for example, alternating between the data packet shown in Table 3 and Table 4 below.

TABLE 4
Sensor Data Packet Alternate 1

| Number of Bits | Data Field |
|---|---|
| 8 | Transmitter Time |
| 14 | Sensor1 Current Data |
| 14 | Sensor1 Historic Data |
| 8 | Transmit Status |
| 12 | AUX Counter |
| 12 | AUX Thermistor 1 |
| 12 | AUX Thermistor 2 |
| 8 | Rolling-Data-1 |

TABLE 5
Sensor Data Packet Alternate 2

| Number of Bits | Data Field |
|---|---|
| 8 | Transmitter Time |
| 14 | Sensor1 Current Data |
| 14 | Sensor2 Current Data |
| 8 | Transmit Status |
| 12 | AUX Counter |
| 12 | AUX Thermistor 1 |
| 12 | AUX Thermistor 2 |
| 8 | Rolling-Data-1 |

As shown above in reference to Tables 4 and 5, the minute by minute data packet transmission from the transmitter 102 (FIG. 1) in one embodiment may alternate between the data packet shown in Table 4 and the data packet shown in Table 5. More specifically, the transmitter 102 may be configured in one embodiment to transmit the current sensor data of the first sensor and the preceding sensor data of the first sensor (Table 4), as well as the rolling data, and further, at the subsequent transmission, the transmitter 102 may be configured to transmit the current sensor data of the first and the second sensor in addition to the rolling data.

In one embodiment, the rolling data transmitted with each data packet may include a sequence of various predetermined types of data that are considered not-urgent or not time sensitive. That is, in one embodiment, the following list of data shown in Table 6 below may be sequentially included in the 8 bits of transmitter data packet, and not transmitted with each data packet transmission of the transmitter (for example, with each 60 second data transmission from the transmitter 102).

TABLE 6
Rolling Data

| Time Slot | Bits | Rolling-Data |
|---|---|---|
| 0 | 8 | Mode |
| 1 | 8 | Glucose1 Slope |
| 2 | 8 | Glucose2 Slope |
| 3 | 8 | Ref-R |
| 4 | 8 | Hobbs Counter, Ref-R |
| 5 | 8 | Hobbs Counter |
| 6 | 8 | Hobbs Counter |
| 7 | 8 | Sensor Count |

As can be seen from Table 6 above, in one embodiment, a sequence of rolling data are appended or added to the transmitter data packet with each data transmission time slot. In one embodiment, there may be 256 time slots for data transmission by the transmitter 102 (FIG. 1), and where, each time slot is separately by approximately 60 second interval. For example, referring to the Table 6 above, the data packet in transmission time slot 0 (zero) may include operational mode data (Mode) as the rolling data that is appended to the transmitted data packet. At the subsequent data transmission time slot (for example, approximately 60 seconds after the initial time slot (0), the transmitted data packet may include the analyte sensor 1 calibration factor information (Glucose 1 slope) as the rolling data. In this manner, with each data transmission, the rolling data may be updated over the 256 time slot cycle.

Referring again to Table 6, each rolling data field is described in further detail for various embodiments. For example, the Mode data may include information related to the different operating modes such as, but not limited to, the data packet type, the type of battery used, diagnostic routines, single sensor or multiple sensor input, type of data transmission (RF communication link or other data link such as serial connection). Further, the Glucose 1-slope data may include an 8-bit scaling factor or calibration data for first sensor (scaling factor for sensor 1 data), while Glucose2-slope data may include an 8-bit scaling factor or calibration data for the second analyte sensor (in the embodiment including more than one analyte sensors).

In addition, the Ref-R data may include 12 bits of on-board reference resistor used to calibrate our temperature measurement in the thermistor circuit (where 8 bits are transmitted in time slot 3, and the remaining 4 bits are transmitted in time slot 4), and the 20-bit Hobbs counter data may be separately transmitted in three time slots (for example, in time slot 4, time slot 5 and time slot 6) to add up to 20 bits. In one embodiment, the Hobbs counter may be configured to count each occurrence of the data transmission (for example, a packet transmission at approximately 60 second intervals) and may be incremented by a count of one (1).

In one aspect, the Hobbs counter is stored in a nonvolatile memory of the transmitter unit 102 (FIG. 1) and may be used to ascertain the power supply status information such as, for example, the estimated battery life remaining in the transmitter unit 102. That is, with each sensor replacement, the Hobbs counter is not reset, but rather, continues the count with each replacement of the sensor unit 101 to establish contact with the transmitter unit 102 such that, over an extended usage time period of the transmitter unit 102, it may be possible to determine, based on the Hobbs count information, the amount of consumed battery life in the transmitter unit 102, and also, an estimated remaining life of the battery in the transmitter unit 102.

That is, in one embodiment, the 20 bit Hobbs counter is incremented by one each time the transmitter unit 102 transmits a data packet (for example, approximately each 60 seconds), and based on the count information in the Hobbs counter, in one aspect, the battery life of the transmitter unit 102 may be estimated. In this manner, in configurations of the transmitter unit 102 where the power supply is not a replaceable component but rather, embedded within the housing of the transmitter unit 102, it is possible to estimate the remaining life of the embedded battery within the transmitter unit 102. Moreover, the Hobbs counter is configured to remain persistent in the memory device of the transmitter unit 102 such that, even when the transmitter unit power is turned off or powered down (for example, during the periodic sensor unit replacement, RF transmission turned off period and the like), the Hobbs counter information is retained.

Referring to Table 6 above, the transmitted rolling data may also include 8 bits of sensor count information (for example, transmitted in time slot 7). The 8 bit sensor counter is incremented by one each time a new sensor unit is connected to the transmitter unit. The ASIC configuration of the transmitter unit (or a microprocessor based transmitter configuration or with discrete components) may be configured to store in a nonvolatile memory unit the sensor count information and transmit it to the primary receiver unit 104 (for example). In turn, the primary receiver unit 104 (and/or the secondary receiver unit 106) may be configured to determine whether it is receiving data from the transmitter unit that is associated with the same sensor unit (based on the sensor count information), or from a new or replaced sensor unit (which will have a sensor count incremented by one from the prior sensor count).

In this manner, in one aspect, the receiver unit (primary or secondary) may be configured to prevent reuse of the same sensor unit by the user based on verifying the sensor count information associated with the data transmission received from the transmitter unit 102. In addition, in a further aspect, user notification may be associated with one or more of these parameters. Further, the receiver unit (primary or secondary) may be configured to detect when a new sensor has been inserted, and thus prevent erroneous application of one or more calibration parameters determined in conjunction with a prior sensor, that may potentially result in false or inaccurate analyte level determination based on the sensor data.

Accordingly, in one aspect, the transmitter unit 102 may be configured to include a task scheduler for initiating various scheduled tasks or functions, and executed by a state machine in the transmitter unit 102. In a further embodiment, a simplified pairing or synchronization between the transmitter unit 102 and the receiver unit 104 may be established using, for example, close proximity commands between the devices. As described above, in one aspect, upon pairing or synchronization, the transmitter unit 102 may be configured to periodically transmit analyte level information to the receiver unit for further processing. Indeed, using a state machine, the transmitter unit 102 may be configured to call and/or execute a predefined or programmed series of functions based on the scheduler 201.

A system in one aspect may include a sensor unit, a transmitter unit operatively coupled to the sensor unit, one or more receiver units to receive signals from the transmitter unit, and a data processing terminal operatively coupled to the one or more receiver units, wherein the transmitter unit comprises, an analog interface to receive data from the sensor unit, a task scheduler circuitry operatively coupled to the analog interface comprising, a counter, a task decoder operatively coupled to the counter, and a finite state machine operatively coupled to the task decoder, wherein the finite state machine is programmed to execute tasks assigned by the task decoder, and a power supply coupled to the task scheduler circuitry.

In one aspect, the tasks executed by the finite state machine may include generating a transmit window, beginning a transmission, ending the transmission, performing a leak test, storing a first and second leak value, performing a temperature measurement test, storing a first and second temperature value, performing a counter voltage test, storing a counter voltage value, performing a reference resistor test, storing a reference resistor value, performing a glucose acquisition, performing a data quality test, storing one or more data quality values, performing a battery status test, performing a low temperature test, and incrementing a rolling glucose data value.

In one aspect, the counter in the task scheduler may be a 21-bit counter running at approximately 32 KHz.

In one aspect, the counter may be reset after time frame that is a predetermined length of time.

In one aspect, the time frame length of time may be approximately 60 seconds.

In one aspect, the tasks executed by the finite state machine may include generating a transmit window, beginning a transmission, ending the transmission, performing a leak test, storing a first and second leak value, performing a temperature measurement test, storing a first and second temperature value, performing a counter voltage test, storing a counter voltage value, performing a reference resistor test, storing a reference resistor value, performing a glucose acquisition, performing a data quality test, storing one or more data quality values, performing a battery status test, performing a low temperature test, and incrementing a rolling glucose data value.

In one aspect, the transmitter unit may be configured to wirelessly transmit signals to the one or more receiver units.

In one aspect, the transmitter unit may further comprise an RF transmitter coupled to the task scheduler circuitry to transmit signals to the one or more receiver units.

In one aspect, the transmitter unit may further comprise a serial communication section coupled to the analog interface.

In one aspect, the transmitter unit may further comprise a memory coupled to the task scheduler circuitry.

In one aspect, the transmitter unit may further comprise a temperature measurement section coupled to the task scheduler circuitry.

In one aspect, the sensor may include a work electrode, a guard contact, a reference electrode and a counter electrode.

In one aspect, the transmitter unit may further comprise a leak detection section coupled to the task scheduler circuitry and a guard contact of the sensor unit.

In one embodiment, an apparatus may be comprised of a counter, a task decoder operatively coupled to the counter, and a finite state machine operatively coupled to the task decoder, wherein the task decoder is programmed to instruct the finite state machine to execute tasks assigned by the task decoder at predetermined counts of the counter.

In one aspect, the counter may be a 21-bit counter running at approximately 32 KHz.

In one aspect, the counter may count from 0 seconds to 60 seconds.

In one aspect, the counter may be recursive.

In one aspect, the tasks executed by the finite state machine may include generating a transmit window, beginning a transmission, ending the transmission, performing a leak test, storing a first and second leak value, performing a temperature measurement test, storing a first and second temperature value, performing a counter voltage test, storing a counter voltage value, performing a reference resistor test, storing a reference resistor value, performing a glucose acquisition, performing a data quality test, storing one or more data quality values, performing a battery status test, performing a low temperature test, and incrementing a rolling glucose data value.

In one embodiment, an apparatus may be comprised of a counter, a task decoder operatively coupled to the counter, and a processor operatively coupled to the task decoder, wherein the task decoder is programmed to instruct the processor to execute tasks assigned by the task decoder at predetermined counts of the counter.

In one aspect, the counter may be a 21-bit counter running at approximately 32 kHz.

In one aspect, the counter may count from 0 seconds to 60 seconds.

In one aspect, the counter may be recursive.

In one aspect, the tasks executed by the finite state machine may include generating a transmit window, beginning a transmission, ending the transmission, performing a leak test, storing a first and second leak value, performing a temperature measurement test, storing a first and second temperature value, performing a counter voltage test, storing a counter voltage value, performing a reference resistor test, storing a reference resistor value, performing a glucose acquisition, performing a data quality test, storing one or more data quality values, performing a battery status test, performing a low temperature test, and incrementing a rolling glucose data value.

A method in one aspect may include providing one or more scheduled tasks associated with an analyte monitoring device and executing the scheduled one or more tasks in accordance with a predetermined execution sequence. The scheduled one or more tasks may be executed using a state machine.

The one or more scheduled tasks may include one or more of generating a transmit window, beginning a transmission, ending the transmission, performing a leak test, storing a first and second leak value, performing a temperature measurement test, storing a first and second temperature value, performing a counter voltage test, storing a counter voltage value, performing a reference resistor test, storing a reference resistor value, performing a glucose acquisition, performing a data quality test, storing one or more data quality values, performing a battery status test, performing a low temperature test, or incrementing a rolling glucose data value.

In one aspect, executing the scheduled one or more tasks may include initiating a count associated with the predetermined execution sequence.

The initiated count may include a predetermined number of counts associated with the scheduled one or more tasks.

Embodiments may include resetting the count.

Also, embodiments may include establishing a time frame for executing the scheduled one or more tasks in accordance with the predetermined execution sequence The time frame is approximately 60 seconds.

A method in another embodiment may include detecting a start command, retrieving a predetermined task schedule time frame for execution of one or more routines associated with analyte level detection, and executing the one or more routines in accordance with the predetermined task schedule time frame.

Embodiments may include determining an analyte level.

Further, embodiments may include transmitting the determined analyte level during the predetermined task schedule time frame.

In one aspect, transmitting the determined analyte level may include wirelessly transmitting one or more signals associated with the determined analyte level to a remote location.

In a further aspect, the start command may be associated with the detection of one or more of a power on routine associated with an analyte monitoring device or a detected close proximity command.

Also, embodiments may include re-executing the one or more routines in accordance with the predetermined task schedule time frame.

Various other modifications and alterations in the structure and method of operation of this disclosure will be apparent to those skilled in the art without departing from the scope and spirit of the disclosure. Although the disclosure has been described in connection with specific preferred embodiments, it should be understood that the disclosure as claimed should not be unduly limited to such specific embodiments. It is intended that the following claims define the scope of the present disclosure and that structures and methods within the scope of these claims and their equivalents be covered thereby.

What is claimed is:

1. A method, comprising:
providing one or more scheduled tasks associated with an analyte monitoring device; and
executing the scheduled one or more tasks in accordance with a predetermined execution sequence using a state machine.

2. The method of claim 1 wherein the one or more scheduled tasks includes one or more of generating a transmit window, beginning a transmission, ending the transmission, performing a leak test, storing a first and second leak value, performing a temperature measurement test, storing a first and second temperature value, performing a counter voltage test, storing a counter voltage value, performing a reference resistor test, storing a reference resistor value, performing a glucose acquisition, performing a data quality test, storing one or more data quality values, performing a battery status test, performing a low temperature test, or incrementing a rolling glucose data value.

3. The method of claim 1 wherein executing the scheduled one or more tasks includes initiating a count associated with the predetermined execution sequence.

4. The method of claim 3 wherein the initiated count includes a predetermined number of counts associated with the scheduled one or more tasks.

5. The method of claim 4 including resetting the count.

6. The method of claim 1 including establishing a time frame for executing the scheduled one or more tasks in accordance with the predetermined execution sequence

7. The method of claim 6, wherein the time frame is approximately 60 seconds.

8. A method, comprising:
detecting a start command;
retrieving a predetermined task schedule time frame for execution of one or more routines associated with analyte level detection; and
executing the one or more routines in accordance with the predetermined task schedule time frame.

9. The method of claim 8 including determining an analyte level.

10. The method of claim 9 including transmitting the determined analyte level during the predetermined task schedule time frame.

11. The method of claim 10 wherein transmitting the determined analyte level includes wirelessly transmitting one or more signals associated with the determined analyte level to a remote location.

12. The method of claim 8 wherein the start command is associated with the detection of one or more of a power on routine associated with an analyte monitoring device or a detected close proximity command.

13. The method of claim 8 including re-executing the one or more routines in accordance with the predetermined task schedule time frame.

14. An apparatus, comprising:
a counter;
a task decoder operatively coupled to the counter; and
a state machine operatively coupled to the task decoder;
wherein the task decoder is programmed to instruct the finite state machine to execute one or more tasks assigned by the task decoder at predetermined counts of the counter.

15. The apparatus of claim 14, wherein the counter is a 21-bit counter.

16. The apparatus of claim 14, wherein the counter counts from 0 seconds to 60 seconds.

17. The apparatus of claim 14, wherein the counter is recursive.

18. The apparatus of claim 14, wherein the one or more tasks executed by the state machine includes one or more of generating a transmit window, beginning a transmission, ending the transmission, performing a leak test, storing a first and second leak value, performing a temperature measurement test, storing a first and second temperature value, performing a counter voltage test, storing a counter voltage value, performing a reference resistor test, storing a reference resistor value, performing a glucose acquisition, performing a data quality test, storing one or more data quality values, performing a battery status test, performing a low temperature test, or incrementing a rolling glucose data value.

19. An apparatus, comprising:
a counter;
a task decoder operatively coupled to the counter; and
a processor operatively coupled to the task decoder;
wherein the task decoder is programmed to instruct the processor to execute one or more tasks assigned by the task decoder at predetermined counts of the counter.

20. The apparatus of claim 19, wherein the counter is a 21-bit counter.

21. The apparatus of claim 19, wherein the counter counts from 0 seconds to 60 seconds.

22. The apparatus of claim 19, wherein the counter is recursive.

23. The apparatus of claim 19, wherein the one or more tasks executed by the finite state machine includes one or more of generating a transmit window, beginning a transmission, ending the transmission, performing a leak test, storing a first and second leak value, performing a temperature measurement test, storing a first and second temperature value, performing a counter voltage test, storing a counter voltage value, performing a reference resistor test, storing a reference resistor value, performing a glucose acquisition, performing a data quality test, storing one or more data quality values, performing a battery status test, performing a low temperature test, or incrementing a rolling glucose data value.
